(19) United States
(12) Patent Application Publication
(10) Pub. No.: US 2013/0011145 A1
(43) Pub. Date: Jan. 10, 2013

(54) IMAGE FORMING APPARATUS, IMAGE FORMING METHOD, AND COMPUTER READABLE MEDIUM

(75) Inventors: Koji NISHIMURA, Kanagawa (JP); Yasuhiro ODA, Kanagawa (JP)

(73) Assignee: FUJI XEROX CO., LTD., Tokyo (JP)

(21) Appl. No.: 13/416,894

(22) Filed: Mar. 9, 2012

(30) Foreign Application Priority Data
Jul. 8, 2011 (JP) 2011-151824

(51) Int. Cl. G03G 15/00; G03G 21/00

(52) U.S. Cl. 399/12; 399/71; 399/346

(57) ABSTRACT

An image forming apparatus includes an image carrier unit, a determining section, an acquiring section, and a removal capability increasing section. The image carrier unit includes an image carrier and a cleaning member, and has a lubricant in the area of the cleaning member that contacts the image carrier when the image carrier unit is in an unused condition. The determining section determines whether or not the image carrier unit is unused. The acquiring section acquires the elapsed time since manufacture of the image carrier unit. The removal capability increasing section increases the removal capability for removing the lubricant from the surface of the image carrier by the cleaning member, in a case where it is determined that the image carrier unit is unused and the acquired elapsed time is equal to or more than a predetermined time, in comparison to other cases.

### CROSS-REFERENCE TO RELATED APPLICATIONS

This application is based on and claims priority under 35 USC 119 from Japanese Patent Application No. 2011-151824 filed Jul. 8, 2011.

### BACKGROUND

### Technical Field

The present invention relates to an image forming apparatus, an image forming method, and a computer readable medium.

### SUMMARY

According to an aspect of the invention, there is provided an image forming apparatus including a body, an image carrier unit including an image carrier that is rotated and carries an image, and is attached to and removed from the body, and a cleaning member that contacts the image carrier to clean a surface of the image carrier by rotation of the image carrier, the image carrier having a lubricant in an area of the cleaning member that contacts the image carrier when the image carrier unit is in an unused condition, a determining section that determines whether or not the image carrier unit attached to the body is unused, an acquiring section that acquires an elapsed time that has elapsed since manufacture of the image carrier unit, and a removal capability increasing section that increases a removal capability for removing the lubricant from the surface of the image carrier by the cleaning member, in a case where it is determined by the determining section that the image carrier unit is unused and the elapsed time acquired by the acquiring section is equal to or more than a predetermined time, in comparison to other cases.

### BRIEF DESCRIPTION OF THE DRAWINGS

Exemplary embodiments of the present invention will be described in detail based on the following figures, wherein:

FIG. 1 illustrates a general structure of an image forming apparatus according to an exemplary embodiment of the invention;

FIG. 2 illustrates a structure in the vicinity of a photoconductor illustrated in FIG. 1;

FIG. 3 illustrates a structure in the vicinity of a cleaning blade in a case where a process cartridge illustrated in FIG. 2 is unused (new);

FIG. 4 is a flowchart of a program executed by a controller illustrated in FIG. 1;

FIG. 5 is a graph representing the relationship between the number of idle rotations of a photoconductor (the number of photoconductor rotations (cleaning time)) performed in a refresh mode illustrated in FIG. 4, and elapsed time T since manufacture of a process cartridge;

FIG. 6 is a graph similar to FIG. 5, illustrating another exemplary embodiment of the refresh mode illustrated in FIG. 4;

FIG. 7 is a graph similar to FIG. 5, illustrating another exemplary embodiment of the refresh mode illustrated in FIG. 4; and

FIG. 8 is a graph similar to FIG. 5, illustrating another exemplary embodiment of the refresh mode illustrated in FIG. 4.

### DETAILED DESCRIPTION

Hereinafter, an image forming apparatus according to an exemplary embodiment of the invention is described with reference to the attached drawings.

(General Structure of Image Forming Apparatus)

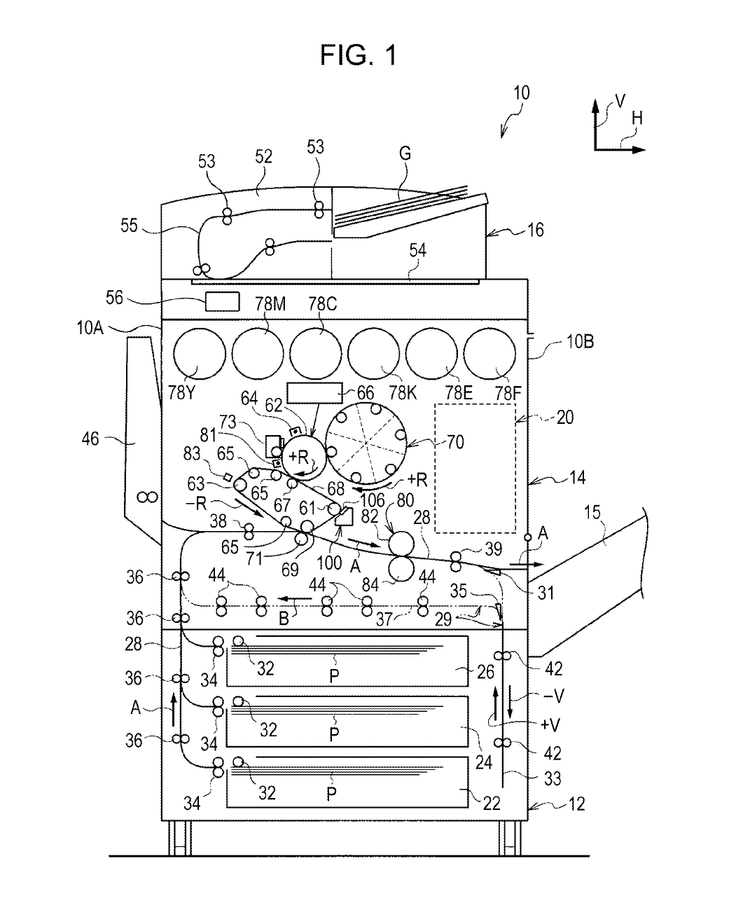

As illustrated in FIG. 1, an image forming apparatus 10 as an example of an image forming apparatus according to an exemplary embodiment of the invention includes a paper storing section 12 in which recording paper P is stored, an image forming section 14 that is provided over the paper storing section 12 and forms an image on the recording paper P supplied from the paper storing section 12, a document reading section 16 that is provided over the image forming section 14 and reads a read document G, and a controller 20 that is provided inside the image forming section 14 and controls the operation of each section of the image forming apparatus 10. The controller 20 is configured by a microcomputer having a central processing unit (CPU), a memory, and a read-only memory (ROM). The controller 20 also has in the inside a timer that can synchronize to the current date and time t1 (described later). In the following description, the vertical direction and the horizontal direction along a body 10A of the image forming apparatus 10 are referred to as arrow V direction and arrow H direction, respectively.

The paper storing section 12 includes a first storing section 22, a second storing section 24, and a third storing section 26 in which sheets of recording paper P of various sizes are stored. The first storing section 22, the second storing section 24, and the third storing section 26 are each provided with a delivery roller 32 that delivers the stored recording paper P to a transport path 28 provided inside the image forming apparatus 10. A pair of transport rollers 34 and a pair of transport rollers 36 that transport the recording paper P sheet by sheet are provided downstream of each of the delivery rollers 32 in the transport path 28. A pair of registration rollers 38 are provided downstream of the transport rollers 36 in the transport direction of the recording paper P in the transport path 28. The registration rollers 38 temporarily stop the recording paper P, and delivers the recording paper P to a second transfer position described later at predetermined timing.

In front view of the image forming apparatus 10, the upstream portion of the transport path 28 is provided so as to extend linearly along the arrow V direction from the left side of the paper storing section 12 toward a lower left portion of the image forming section 14. The downstream portion of the transport path 28 is provided so as to extend from the lower left portion of the image forming section 14 to a paper output section 15 provided on the right side of the image forming section 14. Further, a double-sided transport path 29 is connected to the transport path 28. In the double-sided transport path 29, the recording paper P is transported and reversed in order to form an image on both sides of the recording paper P.

In front view of the image forming apparatus 10, the double-sided transport path 29 has a first switch member 31 in which the transport path 28 and the double-sided transport path 29 are switched, a reverse section 33 that is provided so as to extend linearly along the arrow V direction from a lower right portion of the image forming section 14 to the right side of the paper storing section 12, a transport section 37 where the trailing edge of the recording paper P enters and is transported in the arrow H direction, and a second switch member 35 in which the reverse section 33 and the transport section 37 are switched. In the reverse section 33, pairs of transport rollers 42 are provided at multiple locations so as to be spaced apart from each other. In the transport section 37, pairs of transport rollers 44 are provided at multiple locations so as to be spaced apart from each other.

The first switch member 31 has the shape of a triangular prism. As the tip of the first switch member 31 is moved by a driving section (not illustrated) toward either the transport path 28 or the double-sided transport path 29, the transport direction of the recording paper P is switched. Likewise, the second switch member 35 has the shape of a triangular prism. As the tip of the second switch member 35 is moved by a driving section (not illustrated) toward either the reverse section 33 or the transport section 37, the transport direction of the recording paper P is switched. The downstream end of the transport section 37 is connected by a guide member (not illustrated) on the side upstream from the transport rollers 36 located in the upstream portion of the transport path 28. A folding-type manual paper feed section 46 is provided on the left side of the image forming section 14. The recording paper P can be transported from the manual paper feed section 46 to the registration rollers 38 in the transport path 28.

The document reading section 16 has a document transport device 52 that transports the read document G sheet by sheet, a platen glass 54 that is arranged under the document transport device 52 and on which the read document G is placed, and a document reading device 56 that reads the read document G transported by the document transport device 52 or the read document G placed on the platen glass 54. The document transport device 52 has a transport path 55 in which multiple pairs of transport rollers 53 are arranged. Part of the transport path 55 is arranged in such a way that the recording paper P passes over the platen glass 54. The document reading device 56 is configured to either read the read document G transported by the document transport device 52 while remaining stationary at the left end of the platen glass 54, or read the read document G placed on the platen glass 54 while moving in the arrow H direction.

On the other hand, in the image forming section 14, a photoconductor 62 is provided as an example of a cylindrical image carrier at the center of the body 10A. The photoconductor 62 is rotated in an arrow +R direction (clockwise direction in FIG. 1) by a driving section (not illustrated), and carries an electrostatic latent image formed by irradiation of light. A corotron-type charging device 64 that charges the surface of the photoconductor 62 is provided at a position above the photoconductor 62 and faces the outer periphery of the photoconductor 62.

An exposing device 66 is provided at a position downstream of the charging device 64 in the rotation direction of the photoconductor 62 and faces the outer periphery of the photoconductor 62. The exposing device 66 is configured to form an electrostatic latent image on the outer periphery of the photoconductor 62 charged by the charging device 64, by irradiation of light (exposure) on the basis of an image signal corresponding to each toner color.

A rotation switching-type developing device 70 is provided downstream of an area irradiated with exposure light from the exposing device 66 in the rotation direction of the photoconductor 62. The developing device 70 develops the electrostatic latent image formed on the outer periphery of the photoconductor 62 with a toner of a predetermined color, thereby rendering the electrostatic latent image visible.

An intermediate transfer belt 68 is provided downstream of the developing device 70 in the rotation direction of the photoconductor 62 and below the photoconductor 62. The toner image formed on the outer periphery of the photoconductor 62 is transferred to the intermediate transfer belt 68. The intermediate transfer belt 68 is in an endless form, and placed around a drive roller 61 that is driven and rotated by the controller 20, a tension applying roller 63 for applying tension to the intermediate transfer belt 68, multiple transport rollers 65 that are driven to rotate while in contact with the back side of the intermediate transfer belt 68, and an auxiliary roller 69 that is driven to rotate while in contact with the back side of the intermediate transfer belt 68 at a second transfer position described later. As the drive roller 61 rotates, the intermediate transfer belt 68 revolves in the arrow −R direction.

A first transfer roller 67 is provided opposite the photoconductor 62 across the intermediate transfer belt 68. The first transfer roller 67 causes the toner image formed on the outer periphery of the photoconductor 62 to be first-transferred to the intermediate transfer belt 68. The first transfer roller 67 is in contact with the back side of the intermediate transfer belt 68, at a position spaced apart from the contact position between the photoconductor 62 and the intermediate transfer belt 68 to the downstream side in the direction of movement of the intermediate transfer belt 68. When power is applied from a power source (not illustrated), the first transfer roller 67 causes the toner image on the photoconductor 62 to be first-transferred to the intermediate transfer belt 68 by the potential difference between the first transfer roller 67 and the photoconductor 62 that is grounded.

Further, a second transfer roller 71 is provided opposite the auxiliary roller 69 across the intermediate transfer belt 68. The second transfer roller 71 causes the toner image first-transferred onto the intermediate transfer belt 68 to be second-transferred to the recording paper P. The position between the second transfer roller 71 and the auxiliary roller 69 serves as a second transfer position where the toner image is transferred to the recording paper P. The second transfer roller 71 is in contact with the front side of the intermediate transfer belt 68. When power is applied from a power source (not illustrated), the second transfer roller 71 causes the toner image on the intermediate transfer belt 68 to be second-transferred to the recording paper P by the potential difference between the second transfer roller 71 and the auxiliary roller 69 that is grounded.

A cleaning device 100 is provided opposite the drive roller 61 across the intermediate transfer belt 68. The cleaning device 100 recovers residual toner remaining on the intermediate transfer belt 68 after the second transfer. In the cleaning device 100, a cleaning blade 106 contacts the intermediate transfer belt 68 to scrape off toner. The cleaning blade 106 of the cleaning device 100, and the second transfer roller 71 are separated from the outer periphery of the intermediate transfer belt 68, until toner images in each color are multiple (first)-transferred to the intermediate transfer belt 68 and second-transferred to the recording paper P.

Further, a position detecting sensor 83 is provided at a position around the intermediate transfer belt 68 and faces the tension applying roller 63. The position detecting sensor 83 detects a predetermined reference position on the intermediate transfer belt 68 by sensing a mark (not illustrated) provided to the front side of the intermediate transfer belt 68, and outputs a position detection signal that is used as a reference signal to start an image formation process.

A cleaning device 73 is provided downstream of the first transfer roller 67 in the rotation direction of the photoconductor 62. The cleaning device 73 cleans residual toner or the like that remains on the surface of the photoconductor 62 without being first-transferred to the intermediate transfer belt 68.

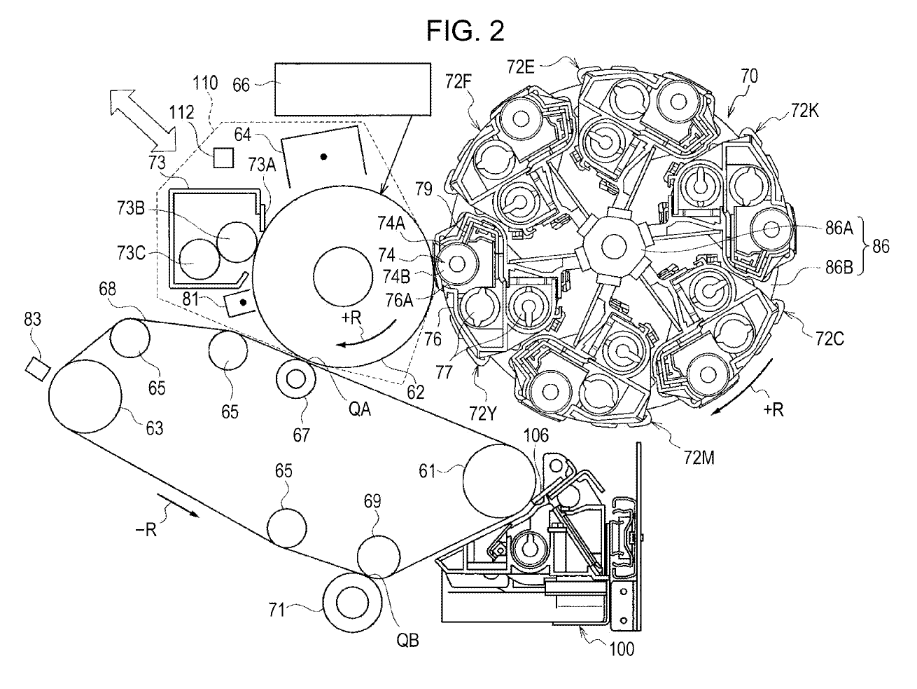

As illustrated in FIG. 2, the cleaning device 73 includes a cleaning blade 73A, a brush roller 73B, and a toner delivery device 73C. The cleaning device 73 is configured to recover residual toner or the like with the cleaning blade 73A and the brush roller 73B each representing an example of a cleaning member that contacts the surface of the photoconductor 62. The recovered residual toner or the like is delivered to the outside of the cleaning device 73 by the toner delivery device 73C having an auger provided inside. A discharging device 81 is provided upstream of the cleaning device 73 (downstream of the first transfer roller 67) in the rotation direction of the photoconductor 62. The discharging device 81 discharges the outer periphery of the photoconductor 62 by irradiating the outer periphery with light. The discharging device 81 is used to apply a bias to the outer periphery of the photoconductor 62 to discharge the outer periphery prior to recovery of residual toner or the like by the cleaning device 73, thereby increasing the recovery ratio of residual toner or the like.

As illustrated in FIG. 1, the second transfer position where the toner image is second-transferred by the second transfer roller 71 is set at some midpoint in the transport path 28 mentioned above. A fixing device 80 is provided downstream of the second transfer roller 71 in the transport direction (illustrated by an arrow A) of the recording paper P in the transport path 28. The fixing device 80 fixes a toner image onto the recording paper P to which the toner image has been transferred by the second transfer roller 71. The fixing device 80 includes a heat roller 82 and a pressure roller 84. The heat roller 82 is arranged on the toner image side (upper side) of the recording paper P, and has a heat source that generates heat when energized. The pressure roller 84 is arranged under the heat roller 82, and presses the recording paper P toward the outer periphery of the heat roller 82. A pair of transport rollers 39 are provided downstream of the fixing device 80 in the transport direction of the recording paper P in the transport path 28. The transport rollers 39 transport the recording paper P toward the paper output section 15 or the reverse section 33.

On the other hand, toner cartridges 78Y, 78M, 78C, 78K, 78E, and 78F respectively containing toner of the colors yellow (Y), magenta (M), cyan (C), black (K), first special color (E), and second special color (F), are provided side by side in the horizontal direction in a manner that allows their replacement, below the document reading device 56 and above the developing device 70.

The first special color E and the second special color F are selected from special colors (including transparent) other than yellow, magenta, cyan, and black, or not selected. In a case where the first special color E and the second special color F are selected, the developing device 70 performs image formation using six colors Y, M, C, K, E, and F. In a case where the first special color E and the second special color F are not selected, the developing device 70 performs image formation using four colors Y, M, C, and K.

In the image forming apparatus 10, an open/close section 10B is provided on the right side of the image forming section 14. The body 10A is opened or closed at the open/close section 10B.

As illustrated in FIG. 2, the developing device 70 includes a rotary member 86 that is rotatably supported. The rotary member 86 includes a rotary shaft member 86A and flange-like members 86B. The rotary shaft member 86A extends along the direction of the rotation axis of the rotary member 86. The flange-like members 86B are provided at both axial ends of the rotary shaft member 86A and extend outwards in a flange-like form in the radial direction of the rotary shaft member 86A.

In the space between the two flange-like members 86B, developing units 72Y, 72M, 72C, 72E, and 72F respectively corresponding to the toner colors yellow (Y), magenta (M), cyan (C), black (K), first special color (E), and second special color (F), are arranged side by side in the circumferential direction of the rotary shaft member 86A (in this order in the counter-clockwise direction in FIG. 2).

In the developing device 70, as the rotary member 86 is rotated by a motor (not illustrated) in the arrow +R direction by a central angle of 60° at a time, the developing units 72Y, 72M, 72C, 72K, 72E, and 72F that perform development are switched from one another so as to face the outer periphery of the photoconductor 62. Since the developing units 72Y, 72M, 72C, 72K, 72E, and 72F are of the same structure, the developing unit 72Y is described here, and a description of the other developing units 72M, 72C, 72K, 72E, and 72F is omitted.

The developing unit 72Y has a case member 76 serving as its body. The case member 76 is filled with developer (not illustrated) made up of toner and carrier supplied from the toner cartridge 78Y (see FIG. 1) via a toner supply path (not illustrated). In the case member 76, a rectangular opening 76A is formed facing the outer periphery of the photoconductor 62. A developing roller 74 whose outer periphery faces the outer periphery of the photoconductor 62 is provided in the opening 76A. The developing roller 74 is rotatably supported by the case member 76. Further, in an area close to the opening 76A inside the case member 76, a plate-like regulation member 79 is provided along the longitudinal direction of the opening 76A. The regulation member 79 is used to regulate the layer thickness of the developer transported by the developing roller 74.

The developing roller 74 includes a cylindrical developing sleeve 74A that is rotatably provided, and a magnetic member 74B that is secured inside the developing sleeve 74A and includes multiple magnetic poles. In the developing roller 74, a magnetic brush of developer (carrier) is formed as the developing sleeve 74A rotates, and the layer thickness of the developer is regulated by the regulation member 79, thereby forming a developer layer on the outer periphery of the developing sleeve 74A. Then, the developer layer on the outer periphery of the developing sleeve 74A is transported to a position where the developer layer faces the photoconductor 62, and a toner corresponding to the latent image (electrostatic latent image) formed on the outer periphery of the photoconductor 62 is adhered to the outer periphery, thereby developing the latent image.

Inside the case member 76, two transport rollers 77 formed in a spiral form are rotatably arranged in parallel. As the two transport rollers 77 rotate, the developer in the case member 76 is circulated and transported in the axial direction of the developing roller 74 (longitudinal direction of the developing unit 72Y). The six developing rollers 74 respectively provided in the developing units 72Y, 72M, 72C, 72K, 72E, and 72F are arranged in the circumferential direction in such a way that adjacent developing rollers 74 are separated by a central angle of 60°. As the developing units 72 are switched from one to another, the next developing roller 74 comes to face the outer periphery of the photoconductor 62.

Next, an image formation process in the image forming apparatus 10 is described.

As illustrated in FIG. 1, when the image forming apparatus 10 is activated, pieces of image data respectively corresponding to the colors yellow (Y), magenta (M), cyan (C), black (K), first special color (E), and second special color (F) are sequentially outputted to the exposing device 66 from an image processing device (not illustrated) or from the outside. At this time, as an example, the developing device 70 is rotated and held in such a way that the developing unit 72Y (see FIG. 2) faces the outer periphery of the photoconductor 62.

Subsequently, the outer periphery (surface) of the photoconductor 62 charged by the charging device 64 is exposed to the light emitted from the exposing device 66 in accordance with image data, thereby forming an electrostatic latent image corresponding to the image data of yellow on the surface of the photoconductor 62. Further, the electrostatic latent image formed on the surface of the photoconductor 62 is developed as a toner image of yellow by the developing unit 72Y. Then, the toner image of yellow on the surface of the photoconductor 62 is transferred to the intermediate transfer belt 68 by the first transfer roller 67.

Subsequently, as illustrated in FIG. 1, the developing device 70 is rotated by 60° in the arrow +R direction, causing the developing unit 72M to face the surface of the photoconductor 62. Then, the processes of charging, exposure, and development are carried out, so that a toner image of magenta on the surface of the photoconductor 62 is transferred onto the toner image of yellow on the intermediate transfer belt 68 by the first transfer roller 67. Likewise, toner images of cyan (C), black (K), first special color (E), and second special color (F) are sequentially multiple-transferred onto the intermediate transfer belt 68.

On the other hand, the recording paper P that has been delivered from the paper storing section 12 and transported on the transport path 28 is transported to the second transfer position by the registration rollers 38, in synchronization with the timing of multiple-transfer of each toner image to the intermediate transfer belt 68. Then, the each toner image multiple-transferred to the intermediate transfer belt 68 is second-transferred by the second transfer roller 71 onto the recording paper P that has been transported to the second transfer position.

Subsequently, the recording paper P with the transferred toner image is transported in the arrow A direction (rightwards in FIG. 1) toward the fixing device 80. Then, in the fixing device 80, heat and pressure are applied to the toner image by the heat roller 82 and the pressure roller 84, thereby fixing the toner image to the recording paper P. Further, the recording paper P with the fixed toner image is ejected to, for example, the paper output section 15. In the case of forming an image on both sides of the recording paper P, after having an image fixed onto its front side by the fixing device 80, the recording paper P is fed to the reverse section 33 and reversed, and is then transported to the second transfer position. Then, an image is formed and fixed onto the back side of this recording paper P.

(With Regard to Process Cartridge)

As illustrated in FIG. 2, the photoconductor 62, the charging device 64, the cleaning device 73, and the discharging device 81 are integrated as a process cartridge 110 as an example of an image carrier unit. The process cartridge 110 can be attached/removed (replaced) to/from the body 10A (see FIG. 1) of the image forming apparatus 10.

The process cartridge 110 has a non-volatile memory 112 in the inside. The memory 112 stores various kinds of information related to the process cartridge 110, such as information related to the date and time of manufacture of the process cartridge 110, and information for determining whether or not the process cartridge 110 is unused (new).

An unused (new) process cartridge 110 is described. In the case of an unused (new) process cartridge 110, toner is not yet present in the area of the cleaning blade 73A of the cleaning device 73 which contacts the photoconductor 62. In this state, the sliding resistance between the cleaning blade 73A and the photoconductor 62 is large. As a result, the photoconductor 62 is not rotated, or if the photoconductor 62 is forcibly rotated, the cleaning blade 73A tucks against the photoconductor 62.

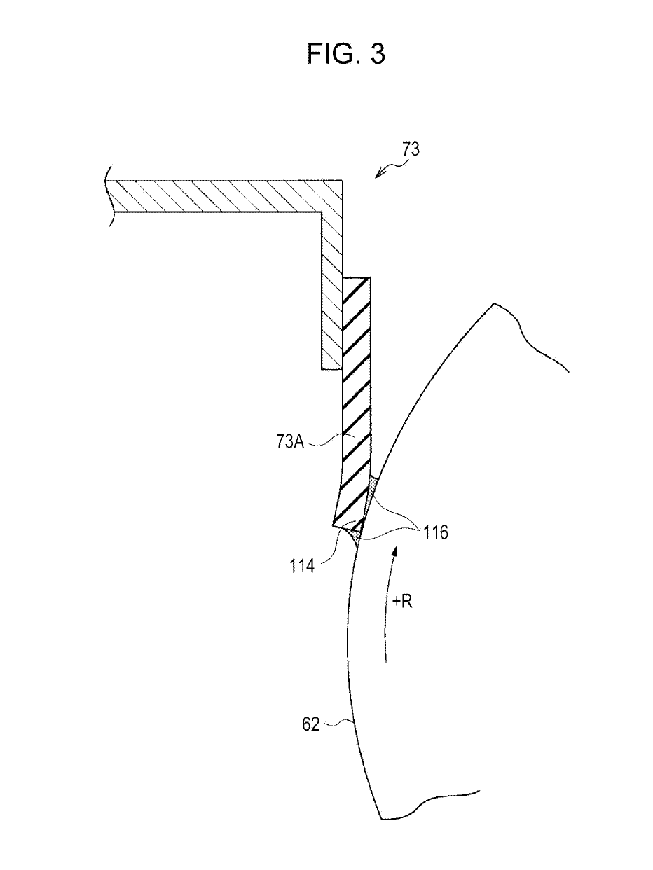

For this reason, in the case of an unused (new) process cartridge 110, as illustrated in FIG. 3, a lubricant 116 such as polymethyl methacrylate (PMMA) is previously applied (caused to be present) in an edge part 114, which is the area of the cleaning blade 73A in contact with the photoconductor 62, so as to ensure smooth rotation of the photoconductor 62 in the initial stage before residual toner becomes present in the area of the cleaning blade 73A that contacts the photoconductor 62 upon performing the image formation process for the first time.

The cleaning blade 73A is made of an elastic material such as rubber, and is made to press the surface of the photoconductor 62. Thus, the lubricant 116 being applied with the pressing force between the cleaning blade 73A and the photoconductor 62 exhibits increased adhesion to the photoconductor 62. Within the lubricant 116 with the increased adhesion, the portion of the lubricant 116 which exhibits particularly strong adhesion relative to areas in the vicinity slips through the edge part 114 of the cleaning blade 73A in spots during the first one or two rotations of the photoconductor 62. As the lubricant 116 slips through the edge part 114, the lubricant 116 is pressed against the surface of the photoconductor 62. This results in the lubricant 116 adhering to the photoconductor 62 in streaks in the circumferential direction of the photoconductor 62 during the first one or two rotations of the photoconductor 62. If the image formation process is executed in this state, an image defect in the form of streaks occurs.

In a case where the photoconductor 62 has a surface coat layer with high surface smoothness (for example, a cross-linked overcoat layer formed by a dehydration-condensation reaction having a surface smoothness such that the average roughness Ra is not more than 0.05 μm and the ten-point average roughness is not more than 0.25 μm), slipping of the lubricant 116 in the edge part 114 easily occurs, and this kind of image defect becomes apparent.

Accordingly, in the image forming apparatus 10 according to this exemplary embodiment, in a case where an unused (new) process cartridge 110 has been attached, the photoconductor 62 is caused to rotate a necessary, number of times at idle before executing the image formation process. Accordingly, the surface of the photoconductor 62 is cleaned with the cleaning blade 73A for a necessary amount of time, thereby removing the lubricant 116 that has adhered in streaks. In a case where the time elapsed since manufacture of the process cartridge is short, the absolute strength of adhesion of the streaked lubricant 116 is weak, and it is possible to remove the streaked lubricant 116 even by cleaning that is performed in the normal image formation preparation sequence by causing the photoconductor 62 to rotate at idle several times (for example, three times). Therefore, the image forming apparatus 10 according to this exemplary embodiment is configured to clean the surface of the photoconductor 62 in accordance with the time elapsed since manufacture of the process cartridge 110.

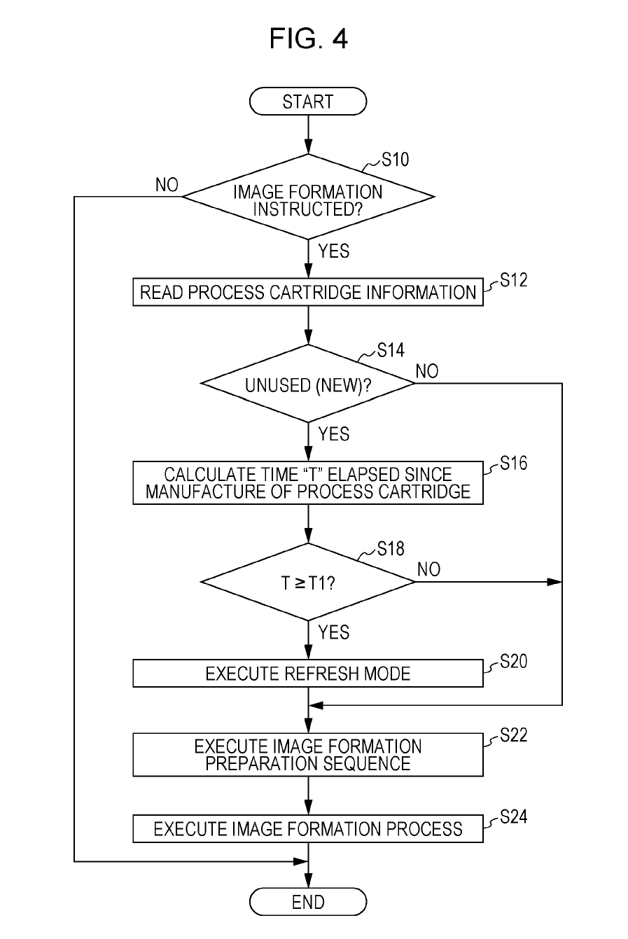

Hereinafter, the above-mentioned process is described in detail. FIG. 4 is a flowchart of a program executed by the controller 20 (see FIG. 1). This program is executed at every predetermined interval of time (for example, 100 msec) after the power to the image forming apparatus 10 is turned on. This program may be previously stored in the ROM of the controller 20, or may be stored in a portable recording medium such as a compact disc or a USB memory and read by the controller 20 to be executed.

First, in step S10, it is determined whether or not image formation has been instructed. If the determination result in step S10 is negative, this program is ended. On the other hand, if the determination result in step S10 is positive, the processing proceeds to step S12.

In step S12, information about the process cartridge 110 is read. Specifically, the memory 112 of the process cartridge 110 is accessed to read the manufacturing date and time t0 of the process cartridge 110 and a flag f related to the usage state of the process cartridge 110. The flag f indicates that the process cartridge 110 is unused (new) when its value is 0, and indicates that the process cartridge 110 is not unused (new) when its value is 1. The value of the flag f is rewritten from 0 to 1 when the photoconductor 62 of an unused (new) process cartridge 110 has rotated a predetermined number of times (for example, twice).

Next, the processing proceeds to step S14, and it is determined whether or not the process cartridge 110 is unused (new) (whether the value of the flag f is 0 or 1). If the determination result in step S14 is negative, the processing skips to step S22 described later. On the other hand, if the determination result in step S14 is positive, the processing proceeds to the next step S16.

In step S16, the elapsed time T since manufacture of the process cartridge 110 is calculated (acquired). Specifically, the elapsed time T since manufacture of the process cartridge 110 is calculated (acquired) by performing a comparison operation (t1−t0) between the current date and time t1 as indicated by the timer of the controller 20 and the manufacturing date and time t0 of the process cartridge 110.

Next, the processing proceeds to step S18, and it is determined whether or not the elapsed time T since manufacture of the process cartridge 110 is equal to or more than a predetermined time T1 (for example, 120 hours (five days)). If the determination result in step S18 is negative, the processing skips to step S22 described later. On the other hand, if the determination result in step S18 is positive, the processing proceeds to the next step S20.

In step S20, a refresh mode is executed. A refresh mode is a mode in which, as previously mentioned, by causing the photoconductor 62 to rotate a necessary number of times at idle before executing the image formation process, the surface of the photoconductor 62 is cleaned with the cleaning blade 73A for a necessary amount of time, thereby removing the lubricant 116 that has adhered to the photoconductor 62 in streaks (the portion of the lubricant 116 which may remain in the image formation preparation sequence).

Next, the processing proceeds to step S22, and an image formation preparation sequence is executed. In the image formation preparation sequence, the photoconductor 62 is rotated at idle several times (for example, three times) for the purposes of adjustment of toner density, developing position alignment, alignment with the intermediate transfer belt 68, or the like.

Next, the processing proceeds to step S24, the image formation process is executed, and the program is ended.

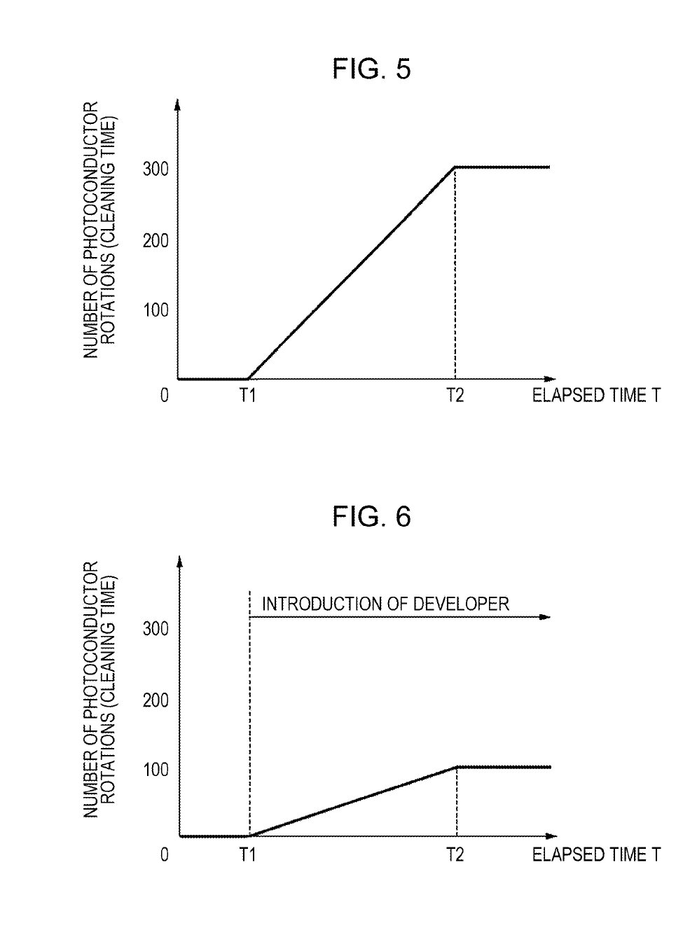

FIG. 5 is a graph representing the relationship between the number of idle rotations of the photoconductor 62 performed in the refresh mode (the number of photoconductor rotations (cleaning time)) and the elapsed time T since manufacture of the process cartridge 110.

As illustrated in FIG. 5, the refresh mode (idle rotation of the photoconductor 62) is executed in a case where the elapsed time T since manufacture of the process cartridge 110 is equal to or more than the time T1 (for example, 120 hours (five days)). In executing the refresh mode (idle rotation of the photoconductor 62), until time T2 (for example, 480 hours (20 days)), the number of idle rotations of the photoconductor 62 (the number of photoconductor rotations (cleaning time)) is increased with increase in the elapsed time T. In a case where the elapsed time T exceeds the time T2, the number of idle rotations of the photoconductor 62 (the number of photoconductor rotations (cleaning time)) is not increased any more but kept constant.

The reason why the refresh mode (idle rotation of the photoconductor 62) is executed in a case where the elapsed time T is equal to or more than the time T1 is that if the elapsed time T is less than the time T1, as previously mentioned, it is possible to remove streaked lubricant 116 by cleaning that is performed in the image formation preparation sequence by causing the photoconductor 62 to rotate at idle several times (for example, three times). Moreover, the reason why the number of idle rotations of the photoconductor 62 (the number of photoconductor rotations (cleaning time)) is increased with increase in the elapsed time T in a case where the elapsed time T is between the time T1 and the time t2 is that the longer the elapsed time since manufacture of the process cartridge 110, the stronger the absolute strength of adhesion of the streaked lubricant 116. In a case where the elapsed time T exceeds the time T2, the absolute strength of adhesion of the streaked lubricant 116 does not increase any more. Accordingly, the number of idle rotations of the photoconductor 62 (the number of photoconductor rotations (cleaning time)) is not increased any more but kept constant.

In this way, the refresh mode is executed in accordance with the elapsed time T since manufacture of the process cartridge 110 so that the lubricant 116 adhering to the surface of the photoconductor 62 is removed appropriately. As a result, wear of the photoconductor 62 due to excessive cleaning of the photoconductor 62 is reduced.

FIG. 6 illustrates another exemplary embodiment of the refresh mode. FIG. 6 is a graph representing the relationship between the number of idle rotations of the photoconductor 62 (the number of photoconductor rotations (cleaning time)) and the elapsed time T since manufacture of the process cartridge 110 in a case where toner (developer) is introduced to the surface of the photoconductor 62 in the refresh mode.

As illustrated in FIG. 6, the refresh mode (idle rotation of the photoconductor 62) is executed in a case where the elapsed time T since manufacture of the process cartridge 110 is equal to or more than the time T1 (for example, 120 hours (five days)). In executing the refresh mode (idle rotation of the photoconductor), toner is introduced from the developing device 70 to the surface of the photoconductor 62 so that the toner becomes present in the edge part 114 of the cleaning blade 73A which contacts the photoconductor 62, thereby increasing the capability for removing the lubricant 116 from the surface of the photoconductor 62 by the cleaning blade 73A. Therefore, until the time T2 (for example, 480 hours (20 days)), the number of idle rotations of the photoconductor 62 (the number of photoconductor rotations (cleaning time)) is increased with increase in the elapsed time T, but the degree of increase is set smaller than that in the case where toner is not introduced (FIG. 5). Toner is introduced from the developing device 70 such that the amount of the toner is selected to cover about 10% of the surface of the photoconductor 62 (area coverage of about 10%). The toner of any color may be introduced from the developing device 70.

In this way, in the case where toner is introduced when executing the refresh mode (idle rotation of the photoconductor), the number of idle rotations of the photoconductor 62 (the number of photoconductor rotations (cleaning time)) is reduced as compared with the case where toner is not introduced (FIG. 5). Therefore, the execution time of the refresh mode (idle rotation of the photoconductor 62) is shortened, and wear of the photoconductor 62 is reduced as a result.

In a case where the elapsed time T exceeds the time T2, as in the case where toner is not introduced (FIG. 5), the number of idle rotations of the photoconductor 62 (the number of photoconductor rotations (cleaning time)) is not increased any more but kept constant.

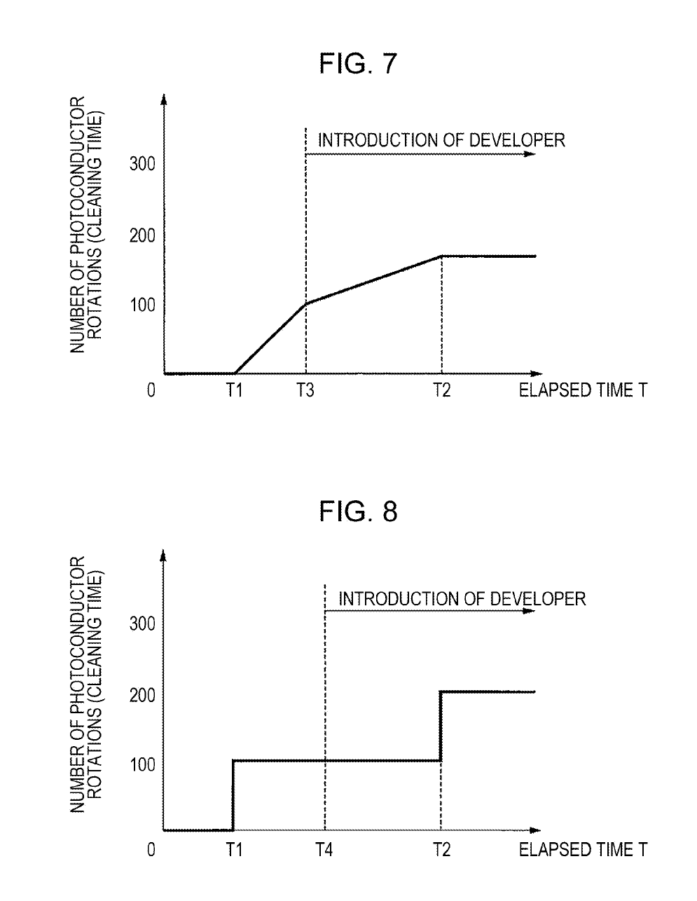

Another exemplary embodiment of the refresh mode (idle rotation of the photoconductor) may be configured as illustrated in FIG. 7. That is, in a case where the elapsed time T is between the time T1 and time T3 (for example, 240 hours (10 days)), toner is not introduced, and the number of idle rotations of the photoconductor 62 (the number of photoconductor rotations (cleaning time)) is increased at a relatively high rate. In a case where the elapsed time T is between the time T3 and the time T2, toner is introduced, and the number of idle rotations of the photoconductor 62 (the number of photoconductor rotations (cleaning time)) is increased at a relatively low rate.

Another exemplary embodiment of the refresh mode (idle rotation of the photoconductor) may be configured as illustrated in FIG. 8. That is, in a case where the elapsed time T is between the time T1 and time T4 (for example, 288 hours (12 days)), toner is not introduced, and the number of idle rotations of the photoconductor 62 (the number of photoconductor rotations (cleaning time)) is set to 100. In a case where the elapsed time T is between the time T4 and the time T2, toner is introduced while setting the number of idle rotations of the photoconductor 62 (the number of photoconductor rotations (cleaning time)) at 100. After the elapsed time T has reached the time T2, the number of idle rotations of the photoconductor 62 (the number of photoconductor rotations (cleaning time)) is set to 200 while introducing toner.

As described above, the image forming apparatus 10 according to this exemplary embodiment is configured to determine whether or not the process cartridge 110 attached to the body 10A of the image forming apparatus 10 is unused (new) (S14), calculate (acquire) the elapsed time T since manufacture of the process cartridge 110 (S16), and execute the refresh mode in a case where it is determined that the process cartridge 110 is unused and the elapsed time T is equal to or more than the time T1 (S20), thereby increasing the removal capability for removing the lubricant 116 from the surface of the photoconductor 62 by the cleaning blade 73A in comparison to other cases.

By increasing the cleaning time for cleaning the surface of the photoconductor 62 by the cleaning blade 73A, the removal capability for removing the lubricant 116 from the surface of the photoconductor 62 by the cleaning blade 73A is increased.

The cleaning time for cleaning the surface of the photoconductor 62 by the cleaning blade 73A is increased with increase in the elapsed time T.

Toner is caused to be present in the edge part 114 of the cleaning blade 73A which contacts the photoconductor 62.

The above-mentioned configuration is implemented by causing the controller 20 to execute a program.

According to the above-mentioned configuration, the image formation preparation sequence is executed after the refresh mode is executed. However, the refresh mode may be executed after the image formation preparation sequence is executed.

While it has been described above that the photoconductor 62, the charging device 64, the cleaning device 73, and the discharging device 81 are integrated in the process cartridge 110, the charging device 64 and the discharging device 81 may be separate components.

While the above description is directed to the case of the image forming apparatus 10 of a rotary type, the exemplary embodiment of the invention can be also implemented by a tandem-type image forming apparatus. In the case of a tandem-type image forming apparatus, the refresh mode is executed after the first transfer roller corresponding to the process cartridge on which to execute the refresh node is retracted from the photoconductor. This prevents idle rotation being executed for the photoconductor of a process cartridge for which it is not necessary to execute the refresh mode.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a body;
an image carrier unit including
an image carrier that is rotated and carries an image, and is attached to and removed from the body, and
a cleaning member that contacts the image carrier to clean a surface of the image carrier by rotation of the image carrier,
the image carrier having a lubricant in an area of the cleaning member that contacts the image carrier when the image carrier unit is in an unused condition;
a determining section that determines whether or not the image carrier unit attached to the body is unused;
an acquiring section that acquires an elapsed time that has elapsed since manufacture of the image carrier unit; and
a removal capability increasing section that increases a removal capability for removing the lubricant from the surface of the image carrier by the cleaning member, in a case where it is determined by the determining section that the image carrier unit is unused and the elapsed time acquired by the acquiring section is equal to or more than a predetermined time, in comparison to other cases.

2. The image forming apparatus according to claim 1, wherein the removal capability increasing section increases a cleaning time for cleaning the surface of the image carrier by the cleaning member.

3. The image forming apparatus according to claim 2, wherein the removal capability increasing section increases the cleaning time with increase in the elapsed time acquired by the acquiring section.

4. The image forming apparatus according to claim 1, wherein the removal capability increasing section causes a developer for developing the image on the image carrier to be provided in the area of the cleaning member that contacts the image carrier.

5. The image forming apparatus according to claim 2, wherein the removal capability increasing section causes a developer for developing the image on the image carrier to be provided in the area of the cleaning member that contacts the image carrier.

6. The image forming apparatus according to claim 3, wherein, the removal capability increasing section causes a developer for developing the image on the image carrier to be provided in the area of the cleaning member that contacts the image carrier.

7. An image forming method comprising:
determining whether or not an image carrier unit attached to a body of an image forming apparatus is unused;
acquiring an elapsed time that has elapsed since manufacture of the image carrier unit; and
increasing a removal capability for removing a lubricant from a surface of the image carrier, in a case where it is determined that the image carrier unit is unused and the acquired elapsed time is equal to or more than a predetermined time, in comparison to other cases.

8. A computer readable medium storing a program causing a computer to execute a process, the process comprising:
determining whether or not an image carrier unit attached to a body of an image forming apparatus is unused;
acquiring an elapsed time that has elapsed since manufacture of the image carrier unit; and
increasing a removal capability for removing a lubricant from a surface of the image carrier, in a case where it is determined that the image carrier unit is unused and the acquired elapsed time is equal to or more than a predetermined time, in comparison to other cases.
